(19) United States
(12) Patent Application Publication
(10) Pub. No.: US 2019/0339692 A1
(43) Pub. Date: Nov. 7, 2019

(54) MANAGEMENT DEVICE AND MANAGEMENT METHOD

(71) Applicant: Panasonic Intellectual Property Management Co., Ltd., Osaka (JP)

(72) Inventors: JUNICHI SAKAI, Kanagawa (JP); NORIHIKO KOBAYASHI, Tokyo (JP); HIDEYUKI TAKAHASHI, Kanagawa (JP)

(21) Appl. No.: 16/517,745

(22) Filed: Jul. 22, 2019

Related U.S. Application Data
(63) Continuation of application No. PCT/JP2018/005424, filed on Feb. 16, 2018.

(30) Foreign Application Priority Data
Feb. 28, 2017 (JP) 2017-037412

(51) Int. Cl. G05D 1/00; G08G 1/00; G05D 1/02

(52) U.S. Cl. CPC G05D 1/0027; G05D 1/0297; G05D 1/0061; G08G 1/202

(57) ABSTRACT

A management device manages statuses of plural autonomous vehicles and statuses of plural remote drivers, where the remote drivers is fewer than the autonomous vehicles. This management device includes an input circuit and an output circuit. The input circuit receives information indicating the respective statuses of the plural autonomous vehicles from the plural autonomous vehicles via a network. When it is necessary to change an autonomous traveling mode of one of the plural autonomous vehicles to a remote operation mode, the output circuit outputs an allocation signal indicating that one of stand-by remote drivers among the plural remote drivers is allocated to the one of the plural autonomous vehicles.

### CROSS REFERENCE TO RELATED APPLICATIONS

This application is a continuation of the PCT International Application No. PCT/JP2018/005424 filed on Feb. 16, 2018, which claims the benefit of foreign priority of Japanese patent application No. 2017-037412 filed on Feb. 28, 2017, the contents all of which are incorporated herein by reference.

### BACKGROUND

### 1. Technical Field

The present disclosure relates to a management device, and a management method for managing autonomous vehicles and remote operators who remotely operate the autonomous vehicles.

### 2. Description of the Related Art

In recent years, there has been acceleration of the development of autonomous vehicles. The development of unmanned vehicles which do not require drivers is also progressing. The unmanned vehicles show promise for application to service vehicles such as taxis, buses, and cargo trucks. However, it is expected to take many years to realize fully autonomous driving defined by the National Highway Traffic Safety Administration (NHTSA) as Level 4. As of 2017, international studies and discussion on legislation are in progress with a stance of allowing unmanned autonomous driving on the condition that remote control from a remote monitoring center is available. Thus, the technology of remote operation is critical in implementing an unmanned autonomous vehicle (for example, refer to Unexamined Japanese Patent Publication No. H10-55496 and Unexamined Japanese Patent Publication No. 2007-334765).

### SUMMARY

Merely monitoring and operating a single autonomous vehicle by a single remote operator does not contribute to a reduction in labor cost for drivers or a solution of the driver shortage problem. Therefore, it is conceivable that a single remote operator should monitor and operate a plurality of autonomous vehicles.

The present disclosure provides a technology that makes it possible to efficiently monitor and control plural autonomous vehicles by fewer remote operators than the plural autonomous vehicles.

A management device in an aspect of the present disclosure manages respective statuses of plural autonomous vehicles and statuses of plural remote drivers, where the number of the plural remote drivers is smaller than the number of the plural autonomous vehicles. The management device includes an input circuit and an output circuit. The input circuit receives information indicating the respective statuses of the plural autonomous vehicles from the plural autonomous vehicles via a network. When it is necessary to change an autonomous traveling mode of one of the autonomous vehicles to a remote operation mode, the output circuit outputs an allocation signal indicating that one of stand-by remote drivers among the plurality of remote drivers is allocated as a remote driver who is in charge of remotely operating the one of the autonomous vehicles.

Effective aspects of the present disclosure include any combinations of the above-mentioned components and those obtained by converting the expressions of the present disclosure among, for example, methods, devices, systems and computer programs.

According to the present disclosure, it is possible to efficiently monitor and control plural autonomous vehicles by fewer remote operators than the plural autonomous vehicles.

### BRIEF DESCRIPTION OF DRAWINGS

FIG. 1 is a diagram illustrating an entire configuration of a remote autonomous driving system according to an exemplary embodiment of the present disclosure.

FIG. 2 is a diagram illustrating a configuration of an autonomous vehicle according to the exemplary embodiment of the present disclosure.

FIG. 3 is a diagram illustrating a configuration of a remote operation device according to the exemplary embodiment of the present disclosure.

FIG. 4 is a diagram illustrating an example of remote operation screen displayed on a display of the remote operation device.

FIG. 5 is a diagram illustrating a configuration of a traffic management device according to the exemplary embodiment of the present disclosure.

FIG. 6A is a diagram illustrating an example of a vehicle control table.

FIG. 6B is a diagram illustrating an example of a remote driver control table.

FIG. 7 is a flowchart showing a basic operation of the remote autonomous driving system according to the exemplary embodiment of the present disclosure.

### DETAILED DESCRIPTION OF PREFERRED EMBODIMENTS

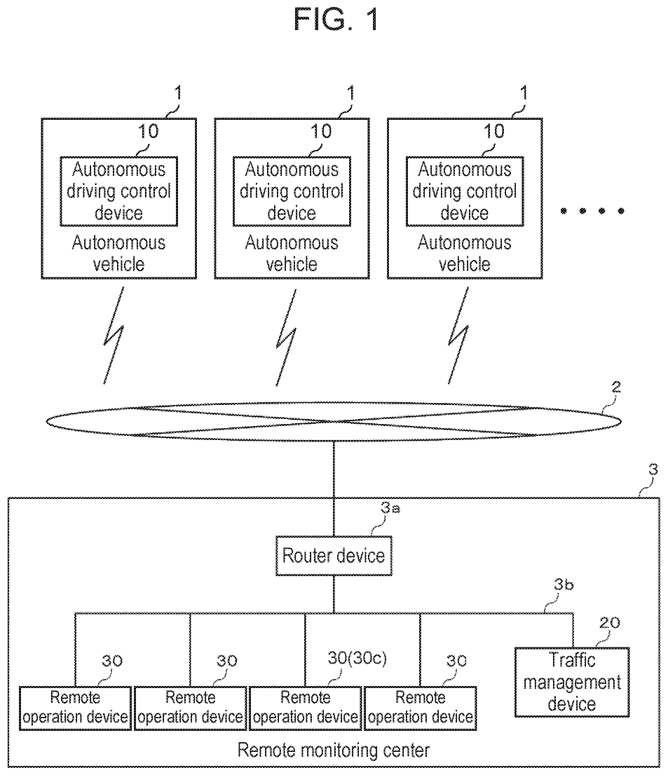

FIG. 1 illustrates the overall configuration of a remote autonomous driving system according to an exemplary embodiment of the present disclosure. The present exemplary embodiment assumes that autonomous vehicle 1 is a service vehicle such as a taxi, a bus, and a cargo truck. Remote monitoring center 3 may take the form of monitoring and controlling autonomous vehicles 1 owned by a single business firm (for example, taxi company A) or may take the form of collectively monitoring and controlling autonomous vehicles 1 owned by two or more business firms (for example, tax company A, taxi company B, bus company C, and delivery company D).

Remote monitoring center 3R is installed with outer device 3a, traffic management device 20, and a plurality of remote-operation devices 30. Traffic management device 20 and the plurality of remote-operation devices 30 are connected over local area network (LAN) 3b and can be connected to Internet 2 via router device 3a.

Each autonomous vehicle 1 includes autonomous driving control device 10. Autonomous driving control device 10 communicates with traffic management device 20 or remote-operation device 30 in remote monitoring center 3 via Internet 2. Note that a dedicated line may be used instead of Internet 2. For example, autonomous driving control device 10 performs bi-directional communication with traffic management device 20 or remote-operation device 30 using a communication scheme (Long-Term Evolution (LTE) or 5th Generation (5G), for example) in which a mobile phone network (cellular network) is involved. A base station device (not illustrated in the drawings) in the mobile phone network transmits a signal received from autonomous driving control device 10 to traffic management device 20 or remote-operation device 30 via an exchange (not illustrated in the drawings), a gateway device (not illustrated in the drawings), Internet 2, and router device 3a in remote monitoring center 3. Furthermore, the base station device receives, via router device 3a in remote monitoring center 3, Internet 2, the gateway device (not illustrated in the drawings), and the exchange (not illustrated in the drawings), a signal transmitted from traffic management device 20 or remote-operation device 30, and transmits the signal to autonomous driving control device 10. Note that a wireless LAN may be used instead of the mobile phone network. The use of a public wireless LAN can reduce communication costs.

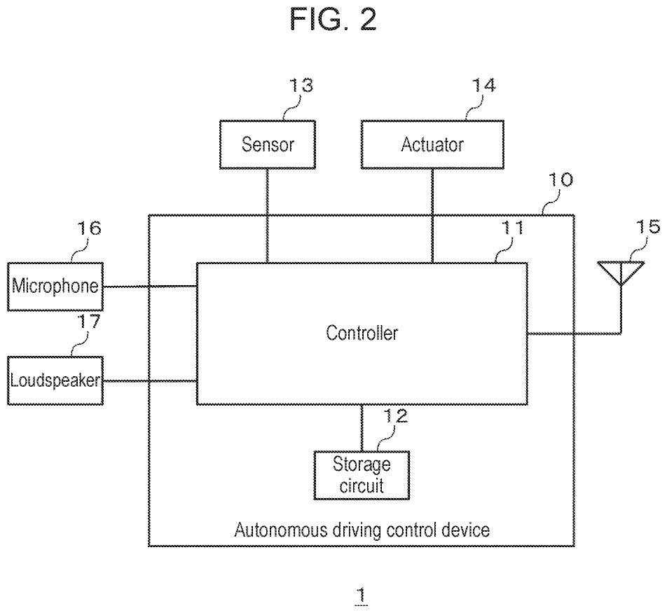

FIG. 2 illustrates the configuration of autonomous vehicle 1 according to the exemplary embodiment of the present disclosure. Autonomous vehicle 1 includes autonomous driving control device 10, sensor 13, actuator 14, antenna 15, microphone 16, and loudspeaker 17. Members that are required for the operation by a driver, such as an accelerator pedal, a brake pedal, and a steering wheel, may be installed in autonomous vehicle 1 or may be omitted.

Actuator 14 is a generic term for members that drive loads related to the travel of vehicles, such as engines, motors, steering, brakes, and lamps. Sensor 13 is a generic term for various sensors that are used to recognize the condition of a user vehicle (a first vehicle) and the circumstances of the area around the user vehicle. For example, a visible light camera, a light detection and ranging (LIDAR) sensor, a millimeter wave radar, a vehicle speed sensor, an acceleration sensor, and a global positioning system (GPS) sensor are provided as sensor 13. Here, the user vehicle is referred the autonomous vehicle which is equipped with autonomous driving control device 10.

The visible light cameras are installed in at least four locations, i.e., on the front, back, left, and right sides of a vehicle, to capture images of the areas ahead, behind, and to the left and right sides of the vehicle. The LIDAR sensor radiates light rays (for example, infrared laser light) to the area surrounding the vehicle, receives reflection signals based on the light rays, and measures, using the received reflection signals, the distance to a target object present in the surrounding area, the size of the target object, and the composition of the target object. The millimeter wave radar radiates electric waves (millimeter waves) to the area surrounding the vehicle, receives reflection signals based on the electric waves, and measures, using the received reflection signals, the distance to a target object present in the surrounding area. The millimeter wave radar is capable of detecting even a target object that is more distant than one detectable with the LIDAR sensor and is difficult to detect with the LIDAR sensor. The vehicle speed sensor detects the speed of autonomous vehicle 1. The acceleration sensor detects the acceleration or the deceleration of autonomous vehicle 1. The global positioning system (GPS) sensor detects the position information of autonomous vehicle 1. Specifically, the GPS sensor receives points in time of transmission from respective GPS satellites, and calculates the latitude and longitude of the receiver position on the basis of the plurality of received points in time of transmission.

Autonomous driving control device 10 includes controller 11 and storage circuit 12. Storage circuit 12 is configured with a hard disk drive (HDD) or a solid-state drive (SSD), for example. Storage circuit 12 holds data required for autonomous driving, such as a three-dimensional map. Controller 11 can be implemented via cooperation of a hardware resource and a software resource or can be implemented using a hardware resource only. As the hardware resource, a processor, a read-only memory (ROM), a random-access memory (RAM), and other large scale integration (LSI) chips can be used. A central processing unit (CPU), a graphic processing unit (GPU), a digital signal processor (DSP), and the like can be used as the processor. As the software resource, an operating system and a program such as an application can be used.

In accordance with a predetermined autonomous driving algorithm, controller 11 causes autonomous vehicle 1 to autonomously travel. Specifically, on the basis of various kinds of detection data obtained by sensor 13 and various kinds of information externally collected over the radio via antenna 15, controller 11 recognizes the circumstances of the user vehicle and the area surrounding the user vehicle. Controller 11 applies various parameters indicating the recognized circumstances to the autonomous driving algorithm and determines an action of autonomous vehicle 1. On the basis of the determined action, controller 11 controls actuator 14.

The autonomous driving algorithm is generated by artificial intelligence (AI) based on deep learning, for example. Various parameters in the autonomous driving algorithm are initially set to values obtained in advance as a result of learning by a high-specification computer, and values updated by a data center on a cloud are downloaded as appropriate.

Controller 11 transmits status information to traffic management device 20 via the network. The status information includes position information and a current status of autonomous vehicle 1. The status is classified, for example, as “self-driving (with a load)”, “self-driving (without a load)”, “standing by in a garage”, “being remotely operated”, “being in emergency stop”, “passenger boarding” and “passenger alighting”.

An emergency stop represents a stop resulting from autonomous travel becoming impossible, and is made due to events such as a sudden approach of a person, a bicycle, and the like, a sudden stop of a preceding vehicle (a second vehicle), cut-in by another vehicle (a second vehicle), and a communication failure. The emergency stop is also made when autonomous route setting becomes impossible due to an inspection, an accident, or traffic control for road construction, and the influence thereof. Note that stopping at a red traffic signal, stopping in congestion, and stopping upon arrival at a destination are not included in the emergency stop.

The “passenger boarding” and “passenger alighting” are statuses used for the taxi and the bus. The “passenger boarding” is a status during which autonomous vehicle 1 stops, one or more passengers get on, and autonomous vehicle 1 starts. The “passenger alighting” is a status during which autonomous vehicle 1 stops, one or more passengers get off, and autonomous vehicle 1 starts. Controller 11 transmits the status information to traffic management device 20 via the network regularly or upon a change in the status.

In the remote-operation mode, controller 11 transmits data of a video captured by the visible light camera to remote-operation device 30 via the network through streaming. Furthermore, controller 11 transmits various kinds of information such as vehicle speed information and obstacle detection information to remote-operation device 30. Controller 11 controls actuator 14 in accordance with a control command received from remote-operation device 30 via the network. Also in a mode other than the remote-operation mode, controller 11 basically transmits data of a video captured by the visible light camera to remote-operation device 30, but may reduce image quality to reduce the amount of data. Furthermore, in the state where safety is secured, transmission of video data may be omitted.

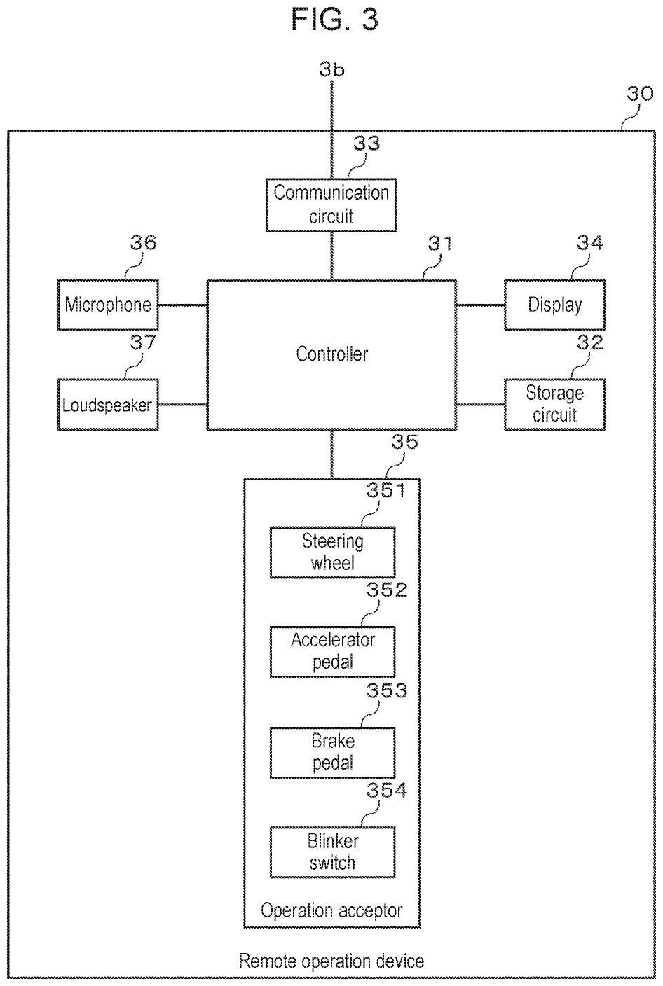

FIG. 3 illustrates the configuration of remote-operation device 30 according to the exemplary embodiment of the present disclosure. Remote-operation device 30 is formed of a personal computer (PC), a monitor, and a control interface, for example. Remote-operation device 30 includes controller 31, storage circuit 32, communication circuit 33, display 34, operation accepter 35, microphone 36, and loudspeaker 37. Communication circuit 33 performs predetermined communication processes for communicating with traffic management device 20 via LAN 3b and with autonomous driving control device 10 via LAN 3b and the external network. Display 34 includes a liquid-crystal display or an organic electroluminescent (EL) display, and displays an image generated by controller 31.

Operation acceptor 35 includes a control interface for remote control which imitates a control interface at the driver seat of autonomous vehicle 1. Specifically, operation acceptor 35 includes steering wheel 351, accelerator pedal 352, brake pedal 353, and blinker switch 354. Operation acceptor 35 may further includes a gear lever, and some meters such as a speed meter and a tachometer. The meters may be displayed as images on display 34. Microphone 36 and loudspeaker 37 are audio interfaces for a user of remote-operation device 30 to talk with a passenger on autonomous vehicle 1.

Storage circuit 32 may be configured, for example, by an HDD or an SSD. Storage circuit 32 retains data that are necessary for monitoring and controlling autonomous vehicle 1, such as a 3-dimensional map which is synchronized with the 3-dimensional map retained in storage circuit 12 of autonomous driving control device 10.

Controller 31 may be implemented by cooperation of a hardware resource and a software resource or by a hardware resource alone. Usable hardware resources include a processor, a ROM, a RAM and other LSIs. Usable processors include, for example, a CPU, a GPU and a DSP. Usable software resources include an operating system and one or more programs such as one or more application programs.

Upon receipt of a remote operation start request from traffic management device 20, controller 31 establishes a communication channel to autonomous driving control device 10 of autonomous vehicle 1 which becomes an object of remote operation and causes display 34 to display a video received from autonomous driving control device 10. At this time, controller 31 may cause display 34 to display a message such as “REMOTE OPERATION IS READY. PLEASE START REMOTE OPERATION”.

Upon viewing this message, a user of remote-operation device 30 (hereafter referred to as a remote driver) begins a start operation for the remote operation, and thus, autonomous driving control device 10 changes over from an autonomous traveling mode to a remote operation mode. Controller 31 produces a control command containing an operation amount given by the remote driver to operation acceptor 35 and transmits the generated control command to autonomous driving control device 10 via the network.

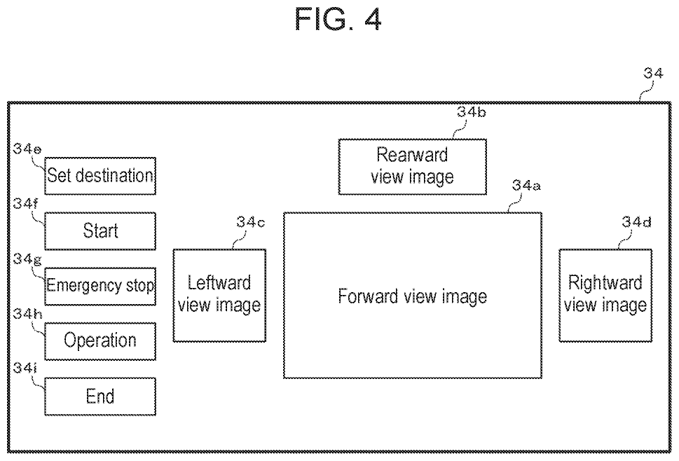

FIG. 4 illustrates an example of a remote operation screen displayed on display 34 of remote-operation device 30. Images displayed on the remote operation screen include forward view image 34a, rearward view image 34b, leftward view image 34c and rightward view image 34d respectively taken by a front camera, a rear camera, a left-side camera and a right-side camera of autonomous vehicle 1 which is the object to be remotely operated.

The remote operation screen also displays, as an operation touch panel, operation buttons including Set destination 34e, Start 34f, Emergency stop 34g, Operation 34h, and End 34i. When the remote driver pushes Set destination 34e, the remote operation screen changes to a destination setting screen. In the “passenger boarding” status, the remote driver talks with the passenger in autonomous vehicle 1 via the audio interface, and then enters a destination instructed by the passenger. In the present exemplary embodiment, it is assumed that, in the “passenger boarding” or “passenger alighting” status, the remote driver deals with a customer (the passenger) using the audio interface without performing the remote operation of actuator 14 of autonomous vehicle 1 using operation acceptor 35.

Pushing Operation 34h causes the remote operation mode to start, and pushing End 34i causes the remote operation mode to end. Pushing Start 34f can cause autonomous vehicle 1 to start moving in the autonomous traveling. Pushing Emergency stop 34g can cause autonomously travelling autonomous vehicle 1 to emergently stop.

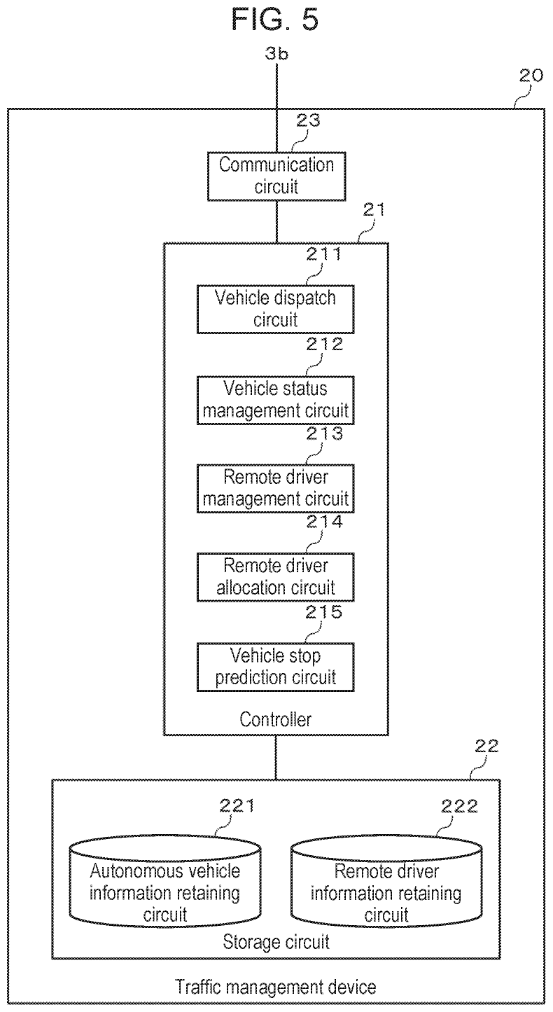

FIG. 5 illustrates a configuration of traffic management device 20 according to the present exemplary embodiment of the present disclosure. Traffic management device 20 may be configured by at least one server or PC. Traffic management device 20 includes controller 21, storage circuit 22, and communication circuit 23. Communication circuit 23 performs a predetermined communication processing to communicate with remote-operation device 30 via LAN 3b and to communicate with autonomous driving control device 10 via LAN 3b and an external network.

Storage circuit 22 may be configured, for example, by an HDD or an SDD. Storage circuit 22 includes autonomous vehicle information retaining circuit 221 and remote driver information retaining circuit 222. Autonoumous vehicle information retaining circuit 221 retains information of autonomous vehicles 1 to be monitored and controlled by remote monitoring center 3. In a case where a certain company establishes remote monitoring center 3 to monitor and control autonomous vehicles 1 owned by the company, autonoumous vehicle information retaining circuit 221 retains information of autonoumous vehicles 1 owned by the company. In a case where a third party establishes remote monitoring center 3, autonoumous vehicle information retaining circuit 221 retains information of autonoumous vehicles 1 owned by each of contracted companies. Remote driver information retaining circuit 222 retains information of remote drivers belonging to remote operation center 3.

Controller 21 includes vehicle dispatch circuit 211, vehicle status management circuit 212, remote driver management circuit 213, remote driver allocation circuit 214, and vehicle stop prediction circuit 215. Functions of controller 21 may be implemented by cooperation of a hardware resource and a software resource or by a hardware resource alone. Usable hardware resources include a processor, a ROM, a RAM and other LSIs. Usable processors include, for example, a CPU, a GPU and a DSP. Usable software resources include an operating system and one or more programs such, for example, as one or more application programs. Such programs may be provided in a form stored in a non-transitory storage medium. Examples of the storage medium include various recording disks and flash memories.

Vehicle dispatch circuit 211 dispatches autonomous vehicle 1 to a requested place at a requested time. In the case of the taxi management, upon receiving a pickup request, dispatch circuit 211 transmits via the network a pickup instruction signal containing a pickup place and a pickup time to autonomous driving control device 10 of one selected from autonomous vehicles 1 in the status of “standing by in a garage” or “self-driving (without a load)”.

Vehicle status management circuit 212 loads from autonomous vehicle information retaining circuit 221 a vehicle control table in which data of autonomous vehicles 1 operating on the day is written. Vehicle status management circuit 212 updates the vehicle control table in real time based on the status information received via the network from autonomous driving control device 10 of each of autonomous vehicles 1, and manages the status of each of autonomous vehicles 1.

Remote driver management circuit 213 loads from remote driver information retaining circuit 222 a remote driver control table in which data of remote drivers working on the day is written. Remote driver management circuit 213 reflects in real time a working situation of each of the remote drivers on the remote driver control table, and manages the status of each of the remote drivers.

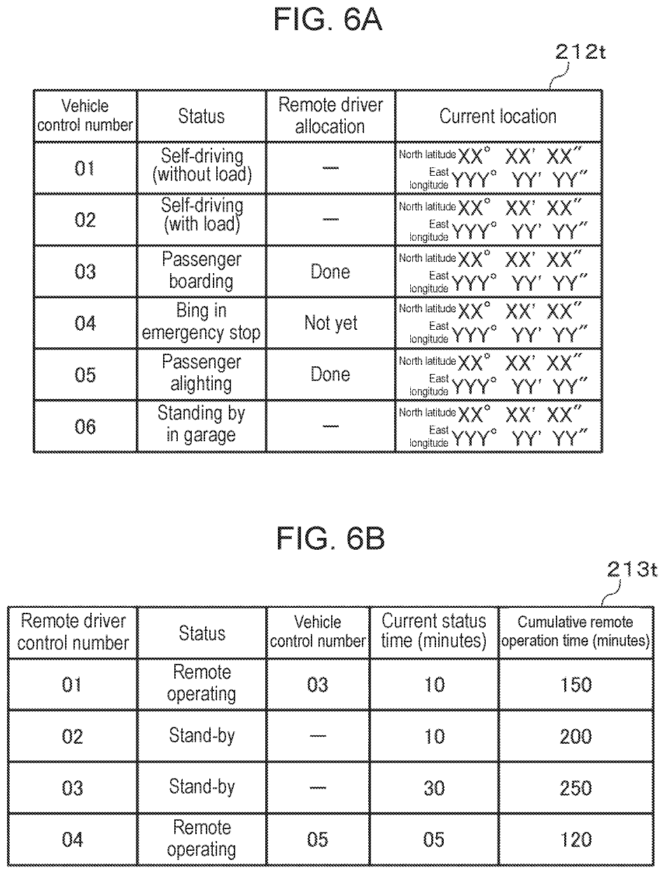

FIGS. 6A and 6B are diagrams illustrating an example of vehicle control table 212t and an example of remote driver control table 213t, respectively. Items managed by vehicle control table 212t shown in FIG. 6A are “vehicle control number”, “status”, “remote driver allocation”, and “current location”. In the column of “remote driver allocation”, the mark “-” indicates a state in which no remote driver is allocated, the mark “DONE” indicates a state in which a remote driver is allocated, and the mark “NOT YET” indicates a state in which a remote driver is required to be allocated, but has not yet been allocated.

Items managed by remote driver control table 213t shown in FIG. 6B are “remote driver control number”, “status”, “vehicle control number”, “current status time”, and “cumulative remote operation time”. A content written in the column of “vehicle control number” is a vehicle control number of autonomous vehicle 1 being operated under a remote operation. A content written in the column of “current status time” is a time elapsed from the start of the current remote operation. A content written in the column of “cumulative remote operation time” is a cumulative time spent for remote operation on the day.

When it is necessary to change the autonomous traveling mode of one of autonomous vehicles 1 to the remote operation mode, remote driver allocation circuit 214 shown in FIG. 5 refers to the remote driver control table 213t and allocates one of stand-by remote drivers to the one of autonomous vehicles 1. The time when it is necessary to change the autonomous traveling mode to the remote operation mode means a time when autonomous vehicle 1 in the status of “self-driving (without a load)” or “self-driving (without a load)” is changed to the status of “being in emergency stop” or “passenger boarding” or “passenger alighting”. Remote driver allocation circuit 214 starts the remote driver allocation processing upon receiving the status information indicating the above-described status change.

In the present exemplary embodiment, the number of the remote drivers asked to come to work is adjusted so that the remote drivers working on the day is fewer than autonomous vehicles 1 operating on the day. If the number of the remote drivers is equal to or larger than the number of autonomous vehicles 1, personal cost reduction is not expected. Further, it is preferable that the number of remote operation devices 30 in remote monitoring center 3 is equal to or larger than the number of the remote drivers working on the day. This allows remote operation device 30 used by each of the remote drivers to be fixed, so that management of the remote drivers becomes easy. Each of the remote drivers sits in front of one of remote-operation devices 30 and waits for the remote operation start request from traffic management device 20, while monitoring at least one of autonomous vehicles 1 via video or the like.

Remote driver allocation circuit 214 selects, as the remote driver to be allocated, a remote driver who has been standing by for the longest time among the stand-by remote drivers. In the case shown in FIG. 6B, the remote drivers in the status of STAND-BY are the remote driver No. 2 and the remote driver No. 3. Since the remote driver No. 3 has been in the status of STAND-BY for the longest time, remote driver allocation circuit 214 selects the remote driver No. 3.

Remote driver allocation circuit 214 transmits an allocation signal containing identification information (e.g., the vehicle control number) of autonomous vehicle 1 to be remotely operated and a remote operation start request to remote-operation device 30c used by the remote driver No. 3 (refer to FIG. 1) via LAN 3b. Remote driver allocation circuit 214 transmits connection destination information (e.g., an IP address) of remote-operation device 30c shown in FIG. 1 to autonomous driving control device 10 of the remotely operated autonomous vehicle 1 via the network.

As a modification, remote driver allocation circuit 214 may select, as the remote driver to be allocated, a remote driver who has the shortest cumulative time spent for remote operation on the day among the stand-by remote drivers. In this case, remote driver allocation circuit 214 selects the remote driver No. 2. Alternatively, remote driver allocation circuit 214 may select a remote driver who has the smallest remote driver control number among the stand-by remote drivers.

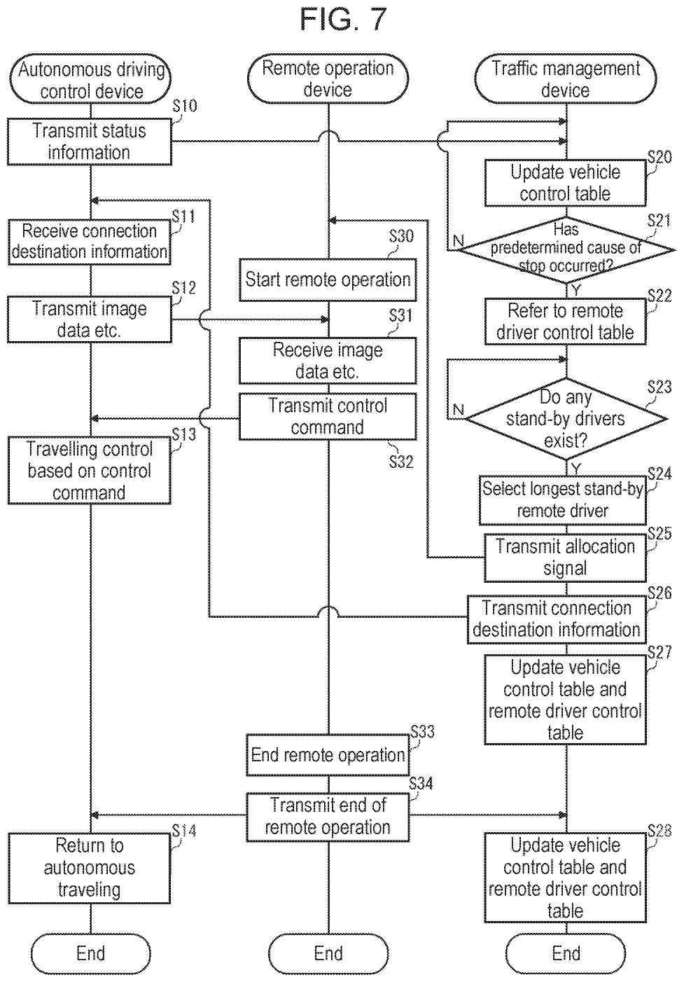

FIG. 7 is a flowchart showing a basic operation of the remote autonomous driving system according to the exemplary embodiment of the present disclosure. Autonomous driving control device 10 transmits the status information of the user vehicle to traffic management device 20 via the network (step S10). Traffic management device 20 updates the vehicle control table based on the received status information of autonomous vehicle 1 (step S20).

Traffic management device 20 determines whether or not such a predetermined cause of stop has occurred that requires a mode change from the autonomous traveling mode to the remote operation mode, based on the received status information of autonomous vehicle 1 (step S21). In a case where a predetermined cause of stop has occurred (Y in step S21), traffic management device 20 refers to the remote driver control table (step S22). Traffic management device 20 checks whether or not one or more stand-by remote drivers exist in the remote driver control table (step S23). In a case where no stand-by remote driver exists (N in step S23), traffic management device 20 waits until an available remote driver appears. During this situation, autonomous vehicle 1 continues staying in the stopped state.

In a case where one or more stand-by remote drivers exist (Y in step S23), traffic management device 20 selects a remote driver who has been standing by for the longest time among the stand-by remote drivers (step S24). Traffic management device 20 transmits an allocation signal to remote-operation device 30 used by the selected remote driver (step S25). A voice announcement notifying that a remote driver is newly selected may be made in remote monitoring center 3. In this case, the announcement massage may contain the name of the selected remote driver and the identification number of remote-operation device 30.

Traffic management device 20 transmits the allocation signal to remote-operation device 30 and also transmits the connection destination information containing the identification information of remote-operation device 30 to autonomous driving control device 10 (step S26). Traffic management device 20 updates the remote driver allocation of the corresponding one of autonomous vehicles 1 in the vehicle control table to “DONE”, and also updates the status of the corresponding remote driver in the remote driver control table to “REMOTE OPERATING” (step S27).

Upon receiving the connection destination information from traffic management device 20 (step S11), autonomous driving control device 10 changes to the remote operation mode and transmits vehicle's various detection information including image data to remote-operation device 30 identified by the connection destination information (step S12).

Upon receiving the allocation signal containing the remote operation start request from traffic management device 20, remote-operation device 30 starts a remote operation based on an operation by the selected remote driver (step S30). Remote-operation device 30 receives the vehicle's various detection information including the image data from autonomous driving control device 10 of the remotely operated autonomous vehicle 1 (step S31). Remote-operation device 30 transmits to autonomous driving control device 10 a control command containing an operation amount given to operation acceptor 35 (step S32). In the case of the status of “passenger boarding” or “passenger alighting”, remote-operation device 30 transmits an audio signal.

Autonomous driving control device 10 controls actuator 14 based on the control command received from remote-operation device 30 (step S13). In the case of the status of “passenger boarding” or “passenger alighting”, voice of the remote driver is outputted from loudspeaker 17.

In a case where the remote driver determines that the predetermined cause of stop of autonomous vehicle 1 has disappeared, remote-operation device 30 transmits a remote operation end notification to traffic management device 20 and autonomous driving control device 10 (step S34). Upon receiving the remote operation end notification, traffic management device 20 updates the remote driver allocation of the corresponding one of autonomous vehicles 1 in the vehicle control table to mark “-”, and also updates the status of the corresponding remote driver in the remote driver control table to “STAND-BY” (step S28). Upon receiving the remote operation end notification, autonomous driving control device 10 returns to the autonomous traveling mode (step S14).

As described above, according to the present exemplary embodiment, it is possible to rapidly and appropriately allocate a stand-by remote driver to autonomous vehicle 1 of which mode is necessary to be changed to the remote operation mode. Accordingly, it is possible to efficiently monitor and control plural autonomous vehicles 1 by fewer remote drivers. Furthermore, since the plural remote drivers are allocated so that the times spent by the remote drivers for performing remote operation are equalized, it is possible to level the loads among the plural remote drivers.

In the above description, the present disclosure is described based on the exemplary embodiment. However, the exemplary embodiment is merely an example. It would be understood by any person skilled in the art that the combination of the components and processes in the exemplary embodiment can be variously modified, and the resultant modifications may be within the scope of the present disclosure.

Although traffic management device 20 allocates a remote driver in response to an occurrence of a predetermined cause of stop, traffic management device 20 may previously allocate a remote driver at a timing of a predetermined period of time before a time at which the predetermined cause of stop is predicted to occur. Specifically, vehicle stop prediction circuit 215 predicts an occurrence time of a predetermined cause of stop. For example, in a case where the predetermined cause of stop is the passenger boarding or the passenger alighting, traffic management device 20 may allocate a remote driver to the corresponding autonomous vehicle 1 five minutes before the predicted time of arrival at the pickup place or the destination place.

Although remote-operation device 30 includes controller 31, storage circuit 32, and communication circuit 33 in the configuration example of the above-described exemplary embodiment, the functions of these components may be integrated to traffic management device 20. In this case, remote-operation device 30 has a role as a console terminal, and traffic management device 20 performs multiple tasks to monitor and control plural autonomous vehicles 1 independently of one another.

The exemplary embodiment may be defined by the following items.

[Item 1]

Management device 20 manages respective statuses of plural autonomous vehicles 1 and statuses of plural remote drivers, where the plural remote drivers is fewer than plural autonomous vehicles 1. Management device 20 includes communication circuit 23 that doubles an input circuit and an output circuit. The input circuit receives information indicating a status of each of the plural autonomous vehicles 1 from the plural autonomous vehicles 1 via the components configuring a network, such as internet 2, router device 3a and LAN 3b, for example. When it is necessary to change a mode of one of autonomous vehicles 1 from an autonomous traveling mode to a remote operation mode, the output circuit outputs an allocation signal indicating that one of stand-by remote drivers among the plural remote drivers is allocated as a remote driver who is in charge of remotely driving the one of autonomous vehicles 1.

This makes it possible to efficiently monitor and control plural autonomous vehicles 1 by fewer remote drivers than the plural autonomous vehicles 1.

[Item 2]

Management device 20 may be connected to plural remote operation devices 30, and the output circuit may output the allocation signal to one of remote operation devices 30 which is used by the one of the remote drivers who is allocated as the remote driver in charge of remotely operating the one of autonomous vehicles 1.

This makes it possible to automatically allocate the remote driver without any manual intervention.

[Item 3]

When it is necessary to change the mode of the one of autonomous vehicles 1 from the autonomous traveling mode to the remote operation mode, the output circuit may output the allocation signal indicating that one of the remote drivers who is standing by for the longest time among the stand-by remote drivers is allocated as the remote driver in charge of remotely operating the one of autonomous vehicles 1. In other words, the allocation signal outputted from the output circuit may indicate that a remote driver who is standing by for the longest time among the plural remote drivers is allocated to the one of autonomous vehicles 1.

This makes it possible to level the loads among the plural remote drivers.

[Item 4] When it is necessary to change the mode of the one of autonomous vehicles 1 from the autonomous traveling mode to the remote operation mode, the output circuit may output the allocation signal indicating that one of the remote drivers who has the shortest cumulative time spent for remote operation on the day among the stand-by remote drivers is allocated as the remote driver in charge of remotely operating the one of autonomous vehicles 1. In other words, the allocation signal outputted from the output circuit may indicate that one of the plural remote drivers who has the shortest cumulative time spent for remote operation on the day among the plural remote drivers is allocated to the one of autonomous vehicles 1.

This makes it possible to level the loads among the plural remote drivers.

[Item 5]

The time when it is necessary to change the mode of the one of autonomous vehicles 1 from the autonomous traveling mode to the remote operation mode may be a time at which management device 20 receives a signal indicating that the one of autonomous vehicles 1 is unable to continue autonomous traveling and stops. In other words, when the input circuit receives the signal indicating that the one of autonomous vehicles 1 is unable to continue autonomous traveling and stops, the output circuit may output the allocation signal.

This makes it possible, when the one of autonomous vehicles 1 comes to an emergency stop, to rapidly restart driving the stopped one of autonomous vehicles 1 through remote operation by a remote driver.

[Item 6]

The one of autonomous vehicles 1 may be a taxi or a bus, and the time when it is necessary to change the mode of the one of autonomous vehicles 1 from the autonomous traveling mode to the remote operation mode may be a time at which the input circuit receives from the taxi or the bus a signal indicating a passenger boarding status or a passenger alighting status. In other words, when the input circuit receives the signal indicating the passenger boarding status or the passenger alighting status, the output circuit may output the allocation signal.

This makes it possible to improve customer service.

[Item 7]

The time when it is necessary to change the mode of the one of autonomous vehicles 1 from the autonomous traveling mode to the remote operation mode may be a timing of a predetermined time before a time at which a predetermined cause of stop is predicted to occur. In other words, the output circuit may output the allocation signal at the timing of the predetermined time before the time at which the predetermined cause of stop is predicted to occur.

This makes it possible to allow the remote operation by the remote driver to rapidly start when the cause of stop occurs.

[Item 8]

According to a management method of the present exemplary embodiment, statuses of plural autonomous vehicles 1 and statuses of plural remote drivers are managed, where the plural remote drivers is fewer than the plural autonomous vehicles. In this management method, information indicating respective statuses of the plural autonomous vehicles 1 is received from the plural autonomous vehicles 1 via a network. When it is necessary to change a mode of one of autonomous vehicles 1 from an autonomous traveling mode to a remote operation mode, one of stand-by remote drivers among the plural remote drivers is allocated as a remote driver who is in charge of remotely driving the one of autonomous vehicles 1.

This makes it possible to efficiently monitor and control plural autonomous vehicles 1 by fewer remote drivers than the plural autonomous vehicles 1.

[Item 9]

A management program of the present exemplary embodiment manages statuses of plural autonomous vehicles 1 and statuses of plural remote drivers, where the plural remote drivers is fewer than the plural autonomous vehicles. The management program causes a computer to perform the following processes: 1) a process of receiving information indicating the respective statuses of the plural autonomous vehicles 1 from the plural autonomous vehicles 1 via a network; and 2) a process of allocating, when it is necessary to change a mode of one of autonomous vehicles 1 from an autonomous traveling mode to a remote operation mode, one of stand-by remote drivers among the plural remote drivers as a remote driver who is in charge of remotely driving the one of autonomous vehicles 1.

This makes it possible to efficiently monitor and control plural autonomous vehicles 1 by fewer remote drivers than the plural autonomous vehicles 1.

The present disclosure is useful as a technology that efficiently monitors and controls plural autonomous vehicles by fewer remote operators than the plural autonomous vehicles.

What is claimed is:

1. A management device for managing respective statuses of plural autonomous vehicles and statuses of plural remote drivers, where a number of the plural remote drivers is smaller than a number of the plural autonomous vehicles, the management device comprising:
an input circuit configured to receive information indicating the respective statuses of the plural autonomous vehicles from the plural autonomous vehicles via a network; and
an output circuit configured to output an allocation signal when it is necessary to change an autonomous traveling mode of one of the plural autonomous vehicles to a remote operation mode, the allocation signal indicating that one of stand-by remote drivers among the plural remote drivers is allocated to the one of the plural autonomous vehicles.

2. The management device according to claim 1,
wherein the management device is connected to plural remote operation devices, and
the output circuit is configured to output the allocation signal to one of the plural remote operation devices which is used by the one of the stand-by remote drivers who is allocated to the one of the plural autonomous vehicles.

3. The management device according to claim 1,
wherein the allocation signal indicates that one of the plural remote drivers who is standing by for a longest time among the plural remote drivers is allocated to the one of the plural autonomous vehicles.

4. The management device according to claim 1,
wherein the allocation signal indicates that one of the plural remote drivers who has a shortest cumulative time spent for remote operation on a day among the plural remote drivers is allocated to the one of the plural autonomous vehicles.

5. The management device according to claim 1,
wherein the output circuit outputs the allocation signal when the input circuit receives a signal indicating that the one of the plural autonomous vehicles is unable to continue the autonomous traveling mode and stops.

6. The management device according to claim 1,
wherein the one of the plural autonomous vehicles is a taxi or a bus, and wherein the output circuit outputs the allocation signal when the input circuit receives a signal indicating a passenger boarding status or a passenger alighting status from the taxi or the bus.

7. The management device according to claim 1,
wherein the output circuit outputs the allocation signal at a timing of a predetermined period of time before a time at which a predetermined cause of stop is predicted to occur on the one of the plural autonomous vehicles.

8. A management method for managing respective statuses of plural autonomous vehicles and statuses of plural remote drivers, where a number of the plural remote drivers is smaller than a number of the plural autonomous vehicles, the management method comprising:
receiving information indicating the respective statuses of the plural autonomous vehicles from the plural autonomous vehicles via a network; and
allocating one of stand-by remote drivers among the plural remote drivers to one of the plural autonomous vehicles when it is necessary to change an autonomous traveling mode of the one of the plural autonomous vehicles to a remote operation mode.

9. The management method according to claim 8,
wherein each of the plural remote drivers uses a remote operation device, and
when allocating the one of the stand-by remote drivers to the one of the plural autonomous vehicles, an allocation signal is output to a remote operation device which is used by the one of the stand-by remote drivers who is allocated to the one of the plural autonomous vehicles.

10. The management method according to claim 8,
wherein, when allocating the one of the stand-by remote drivers to the one of the plural autonomous vehicles, a remote driver who is standing by for a longest time among the plural remote drivers is allocated to the one of the plural autonomous vehicles.

11. The management method according to claim 8,
wherein, when allocating the one of the stand-by remote drivers to the one of the plural autonomous vehicles, a remote driver who has a shortest cumulative time spent for remote operation on a day among the plural remote drivers is allocated to the one of the plural autonomous vehicles.

12. The management method according to claim 8, further comprising determining whether or not the one of the plural autonomous vehicles is unable to continue the autonomous traveling mode and stops,
wherein the one of the stand-by remote drivers is allocated to the one of the plural autonomous vehicles upon determining that the one of the plural autonomous vehicles is unable to continue the autonomous traveling mode and stops.

13. The management method according to claim 8,
wherein the one of the plural autonomous vehicles is a taxi or a bus, and
the management method further comprises determining whether a passenger is boarding the taxi or the bus, a passenger is alighting from the taxi or the bus, or no passenger is boarding or alighting from the taxi or the bus, wherein the one of the stand-by remote drivers is allocated to the one of the plural autonomous vehicles upon determining the passenger is boarding the taxi or the bus or the passenger is alighting from the taxi or the bus.

14. The management method according to claim 8,
wherein the one of the stand-by remote drivers is allocated to the one of the plural autonomous vehicles at a timing of a predetermined period of time before a time at which a predetermined cause of stop is predicted to occur on the one of the plural autonomous vehicles.
